(19) United States
(12) Patent Application Publication
(10) Pub. No.: US 2014/0280483 A1
(43) Pub. Date: Sep. 18, 2014

(54) CLIENT DATABASE CACHE

(71) Applicant: Meteor Development Group, Inc., San Francisco, FL (US)

(72) Inventors: Geoffrey Robert Schmidt, San Francisco, CA (US); Nicholas Martin, Berkeley, CA (US); Matthew DeBergalis, San Francisco, CA (US); Avital Oliver, San Francisco, CA (US)

(21) Appl. No.: 13/837,525

(22) Filed: Mar. 15, 2013

(51) Int. Cl. H04L 29/06

(52) U.S. Cl. CPC H04L 29/06047
USPC 709/203

(57) ABSTRACT

Briefly, embodiments disclosed herein may relate to network database management for online applications and may relate, more particularly, to caching database records for online applications at client computing devices, for example.

### BACKGROUND

1. Field

Subject matter disclosed herein may relate to network database management for online applications and may relate, more particularly, to caching database records for online applications at client computing devices, for example.

2. Information

The success of World Wide Web (Web) type applications continues to change the way the Internet, in general, and the Web, in particular, is utilized. Rather than being merely a convenient way to publish, web pages may be transformed into Web-type computing devices and/or platforms, for example. Compared with desktop applications, systems, such as systems online via the Web, may bring benefits such as, for example, universal accessibility and the ability and/or an ability to readily share, cooperate, and/or communicate with others. Thus, continuing to improve performance remains desirable, as does promoting ease of programming for Web-type application developers, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an example system for establishing and/or maintaining a client-side database cache according to an embodiment.

FIG. 2 is a flow diagram illustrating an example process for establishing and/or maintaining a client-side database cache in accordance with an embodiment.

FIG. 3 is a schematic diagram illustrating an example system for establishing and/or maintaining a client-side database cache according to an embodiment.

FIG. 4 is a schematic diagram illustrating example communications within an example system for establishing and/or maintaining a client-side database cache according to an embodiment.

FIG. 5 is a block diagram illustrating an example system comprising a plurality of computing devices coupled via a network in accordance with an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment and/or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

Operations and/or processing, such as in association with networks, such as communication networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these or similar terms are to be associated with appropriate physical quantities and are intended to merely be convenient labels.

Likewise, in this context, the terms “coupled”, “connected,” and/or similar terms, may be used. It should be understood that these terms are not intended as synonyms. Rather, “connected” may be used to indicate that two or more elements or other components, for example, are in direct physical and/or electrical contact; while, “coupled” may mean that two or more components are in direct physical or electrical contact; however, “coupled” may also mean that two or more components are not in direct contact, but may nonetheless co-operate or interact. The term coupled may also be understood to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description or usage may provide helpful guidance regarding inferences to be drawn.

It should be understood that for ease of description a network device may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

In this context, the term network device refers to any device capable of communicating via and/or as part of a network. Network devices may be capable of sending and/or receiving signals (e.g., signal packets), such as via a wired or wireless network, may be capable of performing arithmetic and/or logic operations, processing and/or storing signals, such as in memory as physical memory states, and/or may, for example, operate as a server. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases and/or portions thereof, as appropriate.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to devices communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long haul public networks that, for example, may allow signal packets to be communicated between LANs. The term world wide web (WWW) and/or similar terms may also be used to refer to the Internet. Signal packets, also referred to as signal packet transmissions, may be communicated between nodes of a network, where a node may comprise one or more network devices, for example. As an illustrative example, but without limitation, a node may comprise one or more sites employing a local network address. Likewise a device, such as a network device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting a network via a hardware bridge as one example may be done, although other approaches also exist. A hardware bridge, however, may not typically include a capability of interoperability via higher levels of a network protocol. A network protocol refers to a set of signaling conventions for communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance or substantial compatibility.

Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. In contrast, a virtual private network (VPN) may enable a remote device to communicate via a local network. A router may allow communications in the form of transmissions (e.g., signal packets), for example, to occur from a remote device to a VPN server on a local network. A remote device may be authenticated and a VPN server, for example, may create a special route between a local network and the remote device through an intervening router.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The internet has evolved to a public, self-sustaining facility that may be accessible to tens of millions of people or more worldwide. Also, in an embodiment, a widely used part of the Internet may comprise the World Wide Web, often abbreviated “WWW” or simply referred to as just “the web”. As mentioned, the terms Internet, web and/or similar terms may, therefore, be used interchangeably. The web, therefore, in this context, may comprise an Internet service that organizes stored content, such as, for example, text, images, video, etc., through the use of hypermedia. For example, a HyperText Markup Language (“HTML”) may be utilized to specify content and/or format of hypermedia type content, such as in the form of a file or an “electronic document,” such as a web page, for example. An Extensible Markup Language (XML) may also be utilized to specify content and/or format of hypermedia type content, such as in the form of a file or an “electronic document,” such as a web page, in an embodiment. Of course, HTML and XML are merely example languages provided as illustrations. Claimed subject matter is not intended to be limited to examples provided as illustrations, of course.

As used herein, a “web site” may refer to a collection of related web pages, in an embodiment. Also as used herein, “web page” may relate to any electronic file or electronic document, such as may be accessible via a network, by specifying a URL for accessibility via the web, in an example embodiment. As alluded to above, in one or more embodiments, a web page may comprise content coded using one or more languages, such as, for example, HTML and/or XML, although claimed subject matter is not limited in scope in this respect. Also, in one or more embodiments, application developers may write code in the form of JavaScript, for example, to provide content to populate one or more templates, such as for an application. However, JavaScript is merely an example programming language. As was mentioned, claimed subject matter is not limited to examples or illustrations.

As used herein, the term “entry”, “electronic entry”, “document”, “electronic document” and/or similar terms are meant to refer to signals and/or states in a digital format that may be perceived by a user if displayed by a digital device, such as, for example, a computing device. For one or more embodiments, an electronic document may comprise a web page coded in a markup language, such as, for example, HTML (hypertext markup language). In another embodiment, an electronic document may comprise a portion or a region of a web page. However, claimed subject matter is not limited in these respects. Also, for one or more embodiments, an electronic document or electronic entry may comprise a number of components. Components in one or more embodiments may comprise text, for example as may be displayed on a web page. Also for one or more embodiments, the components may comprise a graphical object, such as, for example, a digital image, or sub-objects, such as attributes thereof.

As mentioned, the success of World Wide Web (web) type applications, which may be referred to herein as “online applications”, continue to change the way the Internet, in general, and the Web, in particular, is utilized. Web pages may be transformed into Web-type computing devices. Compared with desktop applications, systems, such as systems online via the web, for example, may bring benefits, such as universal accessibility and/or an ability to readily share, cooperate and/or communicate with others. However, development of web-type applications may typically involve a programmer solving many issues and problems that may arise. For example, as online applications become more complex, more and more rendering logic and/or computation may be performed on a client computing device. By performing rendering logic and/or computations at a client computing device, user experience may be improved by providing more responsive user interfaces.

In some online application systems, much and/or all application logic and/or computations may be performed by a server computing device. In many cases, a server computing device may have relatively quick and/or direct access to a database. However, network communication latencies related to communication of application data between a server and a client computing device may be incurred in such systems. Network communication latencies may result in sluggish user interface performance in some situations. Other online application systems may shift online application rendering logic and/or computations to a client computing device. For such systems, network communication latencies may be incurred at least in part because a client computing device does not have quick and/or direct access to a database.

Some online application systems may incorporate a local database cache, perhaps implemented in a browser, which may help reduce round-trip database access latencies. However, such an approach may pose its own difficulties. For example, web browsers typically do not operate in secure environments, which may render any database that may be accessed by an online application vulnerable to attack from malicious users. Security policies may be employed wherein individual types of information requests from client to a server database may employ individual security policies, and it may be difficult to prevent malicious users from attacking any vulnerabilities among individual security policies. Additionally, some online application systems that employ local client-side database caches may have no mechanisms for updating a client in real-time as documents are altered at a server. Also, online application developers may be tasked with writing code to manage a local database cache, and may also be tasked with writing separate code to manage a database to be maintained at a server. Additionally, online application developers may be tasked with writing code to manage secure transactions between a client and a server.

To help improve online application performance and to help make programming of online applications easier for developers, an example embodiment in accordance with claimed subject matter may comprise a server computing device to push a subset of a database to a client computing device in response to a subscription request from a client, and may also comprise a client computing device storing a local copy of a subset of a database.

FIG. 1 is a schematic diagram illustrating an example system embodiment 100 for establishing and/or maintaining a client-side database cache according to an embodiment. For system embodiment 100, a server computing device 110 may establish privileged communications with a database 130, and a client computing device 120 may communicate with server computing device 110 in an non-privileged, or untrusted, manner. In an embodiment, client computing device 110 may transmit a subscription request to server 110, by which client computing device 110 may communicate to server 120 a desire to receive copies of one or more document sets stored in database 130. Also, in an embodiment, at least in part in response to receiving a subscription request from client computing device 110, server computing device 120 may retrieve one or more document sets specified by a subscription request, and may transmit retrieved document sets to client computing device 110. Client computing device 110 may store the document sets received from server 120 in a local database cache.

As used herein, a “document set” represents one or more electronic documents, or portions of electronic documents. Further, in one or more embodiments, a document set may comprise any arbitrary transformation of documents in a database, a join between two or more databases, or any other computation involving a database. Also, in one or more embodiments, contents of a document set may be based at least in part on user specification. However, in one or more embodiments, contents of a document set may be based, at least in part, on other criteria including, for example, time of day, actions of other users, contents of other documents or document sets, and so forth. For example, a document set may comprise a “news feed” in an embodiment. For an example “news feed” embodiment, a user may subscribe to receive all status updates posted by any of the user's friends over a specified period of time, for example over a 10 minute period of time. A user may also specify to receive photographs of any individuals that may have commented on any of the friend's posts. For this particular example, a document set may comprise components that are based at least in part on an individual user's actions, actions taken by other individuals, and may also be based at least in part on a time component. Of course, this is merely a single example of a document set, and claimed subject matter is not limited in scope in these regards.

In an embodiment, an online application executed by client computing device 110 may retrieve data for display from a local database cache, rather than request data from server computing device 120. For example, rather than request specific documents or data from server 120, client computing device 110 may subscribe to one or more document sets stored in database 130. In response to receiving subscription requests from client 110, server computing device 120 may push one or more messages to client computing device 110 to update a local database cache at client computing device 110. In this manner, client computing device 110 may maintain a current, updated copy of a subset of database 130. In an embodiment, server computing device 120 may manage transfer of data from database 130 to client computing device 110. For example, server computing device 120 may determine whether client computing device 110 is authorized to receive particular documents from database 130. Additionally, server computing device 120 may initiate transfer of data from database 130 to client computing device 110.

In an embodiment, server computing device 120 may track changes to database 130, and may determine whether alterations are made to document sets to which client computing device 110 are subscribed. At least in part in response to a determination that an alteration has occurred in a document set to which client device 110 is subscribed, server computing device 120 may push one or more messages to client computing device 110 to communicate alterations to the subscribed document sets. In this manner, client computing device 110 may implement the alterations in its local database cache to maintain up-to-date, current copies of document sets to which client computing device 110 is subscribed. In an embodiment, updates to client computing device 110 local cache database may occur in real time, with server computing device 120 pushing updates to document sets to client computing device 110 at least in part in response to document sets being altered in database 130.

Although example embodiment system 100 depicted in FIG. 1 includes a single client device, other embodiments may incorporate larger numbers of clients. For example, a server computing device, such as server computing device 120, may manage subscription accounts for any number of client devices, in an embodiment. For example, a server computing device, such as server computing device 120, may execute online application code that may read information from a database, such as database 130, and may determine data to push for various client computing devices based, at least in part, on a security policy and/or based, at least in part, on subscription information for individual client computing devices. Also, in an embodiment, online application code may be executed by any number of client computing devices, such as client computing device 110, to read data from respective local database caches and to display the data.

In an embodiment, online application code executed at a server computing device and at a client computing device may access identical or substantially similar application programming interfaces (API) to access a database, such as database 130, or to access a local database cache, as appropriate. By providing a similar API for online application code executed both by server computing devices and by client computing devices, online application development may be made easier and more efficient, for example. As used herein, the term “similar API” refers to an API that may allow for significant code re-use. For example, a code developer may write code for a server portion of an online application, and may reuse significant portions of the server code for a client portion of an online application.

FIG. 2 is a flow diagram illustrating an example process for establishing and/or maintaining a client-side database cache in accordance with an embodiment. The example embodiment of FIG. 2 will be described in conjunction with a description of example system embodiment 300, depicted in FIG. 3. As depicted in FIG. 3, example system embodiment 300 may comprise a client computing device 310, including a local database cache 312, display logic 316, and authentication logic 314. Additionally, as depicted in FIG. 3, a server computing device 320 may comprise a database 322, and a processor to execute publisher code 326 and user ID authentication code 325, for example. As indicated in FIG. 3, publisher code 326 and user ID authentication code 325 may be configured and/or executed on a per-client basis, and any number of client computing devices may be accommodated, in an embodiment. For example, in an embodiment, server 320 may determine on a client-by-client basis which clients are authorized to receive information related to particular document sets stored in database 322. Also, in an embodiment, example system embodiment 300 may include a third-party authentication service 330 that may determine whether a client computing device, such as client 310, is authorized to receive particular document sets stored in database 322. Further, example system embodiment 300 may comprise a network interface, such as network interface 350, by which server computing device 320 may communicate with client computing device 310, for example.

As depicted at block 210 in FIG. 2, a server, such as server 320, may establish and/or maintain a privileged connection with a database, such as database 322, depicted in FIG. 3. As used herein, the term “privileged connection” refers to communications that are compatible and/or compliant with a given security protocol. Additionally, a “privileged connection” may denote that devices connected via such a privileged connection may be authorized according to a particular security protocol to communicate one with another. For example, a server computing device, such as server 320, in an embodiment, may be authorized to access a database, such as database 322, and client computing devices, such as client 310, may not be authorized to access the database. Embodiments in accordance with claimed subject matter may utilize any type of communication security protocol.

As depicted at block 220 of FIG. 2, a client computing device, such as client 310, may communicate with a server computing device, such as server 320, to subscribe to one or more document sets. As mentioned, a document set may comprise one or more documents, or portions thereof, and may be stored in a database, such as database 322, wherein the database may be securely accessed by a server computing device, such as server 320. As also mentioned, a document set may comprise any arbitrary transformation of documents in a database, a join between two or more databases, or any other computation involving a database. At block 230, a server computing device, such as server 320, may push one or more subscribed document sets to a client computing device, such as client 310, at least in part in response to receiving a subscription request from the client computing device.

In an embodiment, a server computing device, such as server 320, may track changes to one or more document sets subscribed to by a client device, such as client device 310. As depicted at block 240 of FIG. 2, a server computing device, such as server 320, may detect one or more alterations to one or more document sets subscribed to by a client computing device, such as client 310. At least in part in response to a server computing device, such as server 320, detecting one or more alterations to one or more document sets subscribed to by a client computing device, such as client 310, a server computing device, such as server 320, may push one or more messages indicating alterations to the one or more document sets to a client computing device, such as client 310, over a network interface, such as network interface 350, as depicted at block 250 of FIG. 2. In an embodiment, a client computing device, such as client 310, may comprise an untrusted client, in that, no elevated security protocols are utilized for communications between a client device, such as client 310, and a server computing device, such as server 320, in an embodiment. That is, communications between a client computing device, such as client 310, and a server computing device, such as server 320, may be accomplished utilizing a general communication protocol for a network interface, such as network interface 350.

Embodiments in accordance with claimed subject matter may include all, more than, or less than blocks 210-250, depicted in FIG. 2. Additionally, the order of blocks 210-250 is merely an example order, and claimed subject matter is not limited in scope in these respects.

Advantages that may be realized through use of one or more embodiments described herein, such as example embodiments depicted in FIGS. 1-3 described above, for example, and/or example embodiment depicted in FIGS. 4-5, described below, may include a client computing device having quick access to data that may be displayed by an online application. Rather than signaling a server computing device to deliver data for display, an online application may retrieve the data for display from a local database cache. Because a server computing device continually pushes any alterations to document sets subscribed to by a client computing device, the client maintains a current copy of the document sets in its local database cache, and the data is ready for quick retrieval. Additionally, client computing devices may be kept up-to-date in real time as changes are made to document sets stored at a database.

FIG. 4 is a schematic diagram illustrating example communications within an example system embodiment 400 for establishing and/or maintaining client-side database caches according to an embodiment. For the discussion that follows in connection with FIG. 4, a particular example database 442 including document sets A, B, and C, will be discussed. A specific example scenario regarding communications between a server 440 and client devices 420 and 430 will also be discussed. However, although specific document sets and specific communications are discussed, these are merely examples, and claimed subject matter is not limited in scope in these respects.

For the example depicted in FIG. 4, documents A, B, and C may be specified as follows:

```
Document A: {
      note: “The eagle soars.”,
      visibleTo: null
}
Document B: {
      note: “The lion roars.”,
      visibleTo: [420]
}
Document C: {
      note: “The beagle snores.”,
      visibleTo: [420, 430]
}
```

For the example depicted in FIG. 4, and as noted above, individual documents A, B, and C may include a textual note and may also include an indication of which clients are permitted to access the document. In an embodiment, an indication of “null” in a “visibleTo” field may indicate that the document is intended for public viewing, and thus may be made visible to every client. For the example depicted in FIG. 4, document A may comprise a textual note of “The eagle soars” that may be visible to everyone. Document B may comprise a textual note of “The lion roars” that may be viewed by client 420. Document C may comprise a textual note of “The beagle snores” that may be viewed by clients 420 and 430.

As mentioned above in connection with FIG. 3, as server, such as server 440, may execute publisher code that, if executed by a server computing device, may manage access to a database, such as database 442. For the example depicted in FIG. 4, server 440 may execute publisher code as follows:

```
return Documents.find({$or: [
      {$in: {visibleTo: this.userID}}, // this user is specifically allowed
      {visibleTo: null}// the list is null, document is public
]});
```

In an embodiment, the example code recited above may retrieve documents visible to clients specified in the “visibleTo” by the “this.userID” variable. For example, if the variable “this.userID” is set to “430” for this particular example, client 430 may be authorized to view the particular document.

Also, in an embodiment, and as mentioned above in connection with FIG. 3, code may be executed at a client computing device to access documents stored in a local database cache for display. For the example depicted in FIG. 4, client computing devices 420 and 430 may execute display code as follows:

Documents.find({ }, {sort: {note: ‘asc’}}).forEach(function (doc) {
addNoteToList(doc.note);
});

It may be noted that the function “Documents.find” is similar in both the publisher code executed by server 440 and in the display code executed by client devices 420 and 430, in an embodiment. As mentioned previously, by providing similar API for both server and client online application code, online application programming may be made easier and more efficient through significant re-use of code, for example. Additionally, it may be noted that the example display code recited above does not check access rules for the database documents because client computing devices do not access database 442, for example, but rather access local database caches, in an embodiment.

Additionally, in an embodiment, similar API shared between a server, such as server 440, and a client, such as client 420, may mirror and/or mimic a previously existing API. A mirrored or mimicked API may provide one or more advantages. For example, a mirrored and/or mimicked API may provide programmer familiarity, which may mean that a programmer may have reduced need to learn a new programming interface. Also, in some situations, pre-existing APIs may have been thoroughly tested and have undergone significant development, and such aspects of pre-existing APIs may be leveraged to at least a degree through mirroring and/or mimicking. Further, for embodiments implementing mirroring and/or mimicking of a pre-existing API, previously existing native database features on a server may also be utilized, which may be helpful in some situations. For example, although native database features may not be accessible to a client API in one or more embodiments, a server API may take advantage of native database features to implement more advanced database interactions. Of course, claimed subject matter is not limited in scope in these respects.

In the example depicted in FIG. 4, client computing device 420 may connect to server 440, as indicated by signal arrow 401. At least in part in response to receiving communication 401 from client computing device 420, server computing device 440 may determine which documents to send to client 420. Because for the present example client 420 has not yet been authenticated, server 440 determines that client 420 is authorized to view document A, which, for the current example is a publicly viewable document. As indicated by arrow 402, server 440 may transmit document A to client computing device 420. At least in part in response to receiving document A from server 440, client computing device 420 may store document A in local database cache 422, for example.

Also, for the example depicted in FIG. 4, client computing device 420 may transmit an authentication message to server 440, as indicated by arrow 404. In an embodiment, an authentication message may comprise an identification for client 420 as well as a password, for example. Of course, this is merely one example of an authentication message, and claimed subject matter is not limited in scope in this respect. Additionally, as mentioned above, authentication services may be provided by a third party, in an embodiment.

In an embodiment, at least in part in response to receiving an authentication message from client computing device 420, server 440 may authenticate client 420, and may re-execute the publisher code to determine whether additional documents ought to be delivered to client 420. As indicated by arrow 405 depicted in FIG. 4, server 440 may transmit documents B and C to client computing device 420. In response to receiving documents B and C from server 440, client computing device may store documents B and C in local database cache 422, as indicated by arrow 406 depicted in FIG. 4. Client computing device 420 may access up-to-date copies of documents A, B, and/or C from local database cache 422, and may display them to a user, for example.

For the example depicted in FIG. 4, client computing device 430 may connect to server 440, as indicated by arrow 407. In an embodiment, server computing device 440 may instantiate an additional instance of publisher code for client computing device 430, and may execute it. Because client 430 is not yet authenticated for the present example, server computing device 440 may transmit document A, designated as a public document, to client computing device 430, and client 430 may store document A in a local database cache 432, as indicated by arrows 408 in FIG. 4.

In an embodiment, alterations may be made to documents stored in a database. In some cases, alterations may be made by an external process executed by a network device, or by some other device or entity. Alterations may include modifying one or more documents, removing a document from a document set, and/or inserting a document or a portion thereof to a document set, for example, although claimed subject matter is not limited in scope in these respects. For the example depicted in FIG. 4, document B may be altered by an external process, as indicated by arrow 409. For the present example, alterations to document B may be labeled as B′.

At least in part in response to an alteration to document B, server computing device 440 may detect the alteration and may determine which clients are authorized to receive indications of the alterations to document B. For the present example, client 430 is not yet authenticated, so alterations to document B are delivered only to client computing device 420, as indicated by arrow 410 depicted in FIG. 4. Also, at least in response to receiving an indication of alterations to document B from server 440, client computing device 420 may replace portions of document B with the altered portions B′ of document B, for example, as indicated by arrow 411 depicted in FIG. 4. In this manner, client computing device 420 may maintain a current, up-to-date copy of document B, including alterations B′ made to document B by an external agent.

For the example of FIG. 4, client computing device 430 may authenticate itself to server computing device 440, for example, as indicated by arrow 412 depicted in FIG. 4. At least in part in response to receiving authentication for client computing device 430, server computing device 440 may re-execute publisher code for client 430, and may determine that client 430 is authorized to view document C. At least in part in response to determining that client computing device 430 is authorized to view document C, server computing device 440 may transmit document C to client 430, as indicated by arrow 413 depicted in FIG. 4. Additionally, as indicate by arrow 414 of FIG. 4, client computing device 430 may store document C in local database cache 432, and may display document C to a user, for example.

In an embodiment, changes may be made to permissions for the various documents and/or document sets in a database, such as database 442, for example. For the example depicted in FIG. 4, client computing device 430 may be added to the “visibleTo” list of document B, as indicated by arrow 415 depicted in FIG. 4. At least in part in response to a change in a “visibleTo” parameter for document B, server computing device 440 may determine which client computing devices are authorized to view document B. At least in part in response to a determination that document B is viewable by client computing device 430, server 440 may transmit document B to client 430, and client 430 may store document B in local database cache 432, for example, as indicated by arrows 416. Client computing device 430 may also display document B to a user, in an embodiment.

In an embodiment, in general, a client computing device, such as client 420, may specify sets of information, or document sets, it is interested in by transmitting subscription, or “sub” messages to a server, such as server 440, for example. In response to receiving a “sub” message from a client device, a server, such as server 440, may at any time deliver data messages related to a subscribed-to document set to the client device. In an embodiment, messages related to a document set subscribed to by a client computing device transmitted by a server to the client may include an “added” message, a “changed” message, and a “remove” message, for example. In an embodiment, an “added” message related to a document set may indicate that a document was added to the particular document set stored in a server database, and that the document should be added to a copy of the document set stored at a client device local database cache. An “added” message may include an identification value for the added document in an “ID” field. Additionally, in an embodiment, field of the added document may be specified by a value in a “fields” field.

Also, in an embodiment, a “changed” message may indicate that a document in a particular document set stored in a server database has new values for one or more fields and/or has had some fields removed, and may indicate that a copy of the specified document stored in a client device local database cache should be similarly changed. An “ID” field in a “changed” message may indicate an identification of the particular document being changed, and a “fields” object in the “changed” message, if present, may indicate fields in the document that should be replaced with new values. A “cleared” field may contain an array of fields that are no longer present in the copy of the document stored at the server database, and that are to be removed from the copy of the document stored at the client computing device's local cache database, in an embodiment. Further, a “removed” message transmitted from a server to a client may indicate that a document was removed from the server database, and that the copy of the specified document stored in a local database cache should also be removed. An “ID” field in the “removed” message may specify a document to be removed, for example.

In an embodiment, a client computing device, such as client 420 or client 430, for example, may maintain a local database cache that may store information related to more than one subscription. In an embodiment, individual subscriptions may not have respective, individual data stores at a client computing device, but rather overlapping subscriptions may result in a server sending a union of facts regarding a particular collection of data. For example, if subscription A indicates that a document X has fields {foo: 1, bar: 2} and subscription B indicates that document X has fields {foo: 1, baz: 3}, a server computing device may inform a client computing device that subscribes to both subscription A and subscription B that document X includes fields {foo: 1, bar: 2, baz: 3}. In an embodiment, data conflicts between subscriptions may be resolved by a server computing device.

As mentioned above, although specific code has been discussed, as well as specific messages between client computing devices and a server computing device, and specific documents, and so on, these are merely examples, and claimed subject matter is not limited in scope in these respects.

FIG. 5 is a block diagram illustrating an example system comprising a plurality of computing devices coupled via a network in accordance with an embodiment. For purposes of illustration, FIG. 5 is an illustration of an embodiment of a computing platform or computing device 504 that may be employed in a client-server type interaction, such as described infra. In FIG. 5, computing device 504, which may comprise features of a server computing device, may interface with a computing device 502, which may comprise features of a client device, for example. In other embodiments, computing device 504 may comprise a client computing device, and computing device 502 may comprise a server computing device, for example. In an embodiment, communications interface 530, processor (e.g., processing unit) 520, and memory 522, which may comprise primary memory 524 and secondary memory 526, may communicate by way of communication bus 528, for example. In FIG. 5, computing device 504 may store various forms of content, such as analog, uncompressed digital, lossless compressed digital, or lossy compressed digital formats for content of various types, such as video, imaging, text, audio, etc. in the form physical states or signals, for example. Computing device 504 may communicate with computing device 502 and/or with computing device 506 by way of an Internet connection via network 508, for example. Although the computing device 504 of FIG. 5 shows the above-identified components, claimed subject matter is not limited to computing devices having only these components as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 520 may be representative of one or more circuits, such as digital circuits, to perform at least a portion of a computing procedure or process. By way of example but not limitation, processor 520 may comprise one or more processors, such as controllers, microprocessors, microcontrollers, application specific integrated circuits, digital signal processors, programmable logic devices, field programmable gate arrays, and the like, or any combination thereof. In implementations, processor 520 may perform signal processing to manipulate signals or states or to construct signals or states, for example.

Memory 522 may be representative of any storage mechanism. Memory 522 may comprise, for example, primary memory 524 and secondary memory 526, additional memory circuits, mechanisms, or combinations thereof may be used. Memory 522 may comprise, for example, random access memory, read only memory, or one or more data storage devices or systems, such as, for example, a disk drive, an optical disc drive, a tape drive, a solid-state memory drive, just to name a few examples. Memory 522 may be utilized to store a program, as an example. Memory 522 may also comprise a memory controller for accessing computer readable-medium 540 that may carry and/or make accessible content, code, and/or instructions, for example, executable by processor 520 or some other controller or processor capable of executing instructions, for example. Also, in an embodiment, memory 522 may store a local database cache, for example.

Under the direction of processor 520, memory, such as cells storing physical states, representing for example, a program, may be executed by processor 520 and generated signals may be transmitted via the Internet, for example. Processor 520 may also receive digitally-encoded signals from server 504.

Network 508 may comprise one or more communication links, processes, and/or resources to support exchanging communication signals between a client and server, which may, for example, comprise one or more servers (not shown). By way of example, but not limitation, network 508 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing device,” as used herein, refers to a system and/or a device, such as a computer, that includes a capability to process and/or store data in the form of signals and/or states. Thus, a computing device, in this context, may comprise hardware, software, firmware, or any combination thereof (other than software per se). Computing device 504, as depicted in FIG. 5, is merely one such example, and the scope of claimed subject matter is not limited to this particular example. For one or more embodiments, a computing device may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing device.

Memory 522 may store cookies relating to one or more users and may also comprise a computer-readable medium that may carry and/or make accessible content, code and/or instructions, for example, executable by processor 520 or some other controller or processor capable of executing instructions, for example. A user may make use of an input device, such as a computer mouse, stylus, track ball, keyboard, or any other device capable of receiving an input from a user.

Regarding aspects related to a communications or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, or other technologies, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device or may otherwise be its primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or combination thereof.

A computing device may vary in terms of capabilities or features. Claimed subject matter is intended to cover a wide range of potential variations. For example, a network device may include a numeric keypad or other display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include or may execute a variety of now known, or to be developed operating systems, or derivatives and/or versions, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute a software application to communicate content, such as, for example, textual content, multimedia content, or the like. A computing device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially complaint with or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, or another existing protocol, or another protocol that may be developed.

A network may be compatible with now known, or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

1. A method, comprising:
pushing a document set from a server computing device to a client computing device at least in part in response to receiving a subscription request to the document set at the server computing device from the client computing device, wherein the server computing device and the client computing device execute application programming interfaces that are substantially similar to each other.

2. The method of claim 1, further comprising:
maintaining a privileged connection between the server computing device and a database comprising the document set; and
retrieving the document set from the database at least in part in response to said receiving the subscription request at the server computing device from the client computing device.

3. The method of claim 2, wherein the client computing device comprises an untrusted client computing device.

4. The method of claim 2, further comprising:
detecting a modification to the document set; and
pushing one or more messages indicative of the modification to the document set from the server computing device to the client computing device at least in part in response to said detecting the modification to the document set.

5. The method of claim 4, wherein said detecting the modification to the document set comprises detecting an insertion of one or more additional documents to the document set and/or a deletion of one or more documents of the document set.

6. The method of claim 4, wherein said detecting the modification to the document set comprises detecting an alteration of one or more documents of the document set.

7. The method of claim 1, wherein said pushing the document set from the server computing device to the client computing device comprises:
determining whether a user associated with the client computing device is authorized to access the document set; and
pushing the document set from the server computing device to the client computing device and at least in part in response to a determination that the user is authorized.

8. The method of claim 7, further comprising pushing messages indicative of alterations to the document set to the client computing device to allow the client computing device to maintain a current copy of the document set in a local database cache.

9. The method of claim 8, wherein said pushing messages indicative of alterations to the document set comprises occasionally pushing the messages at least in part in response to respective detections of the alterations to the document set.

10. A method, comprising:
maintaining one or more copies of one or more document sets from a server-based database at a client computing device at least in part by receiving pushed messages from a server computing device, wherein the server computing device and the client computing device execute respective application programming interfaces that are substantially similar to each other.

11. The method of claim 10, wherein said maintaining the one or more copies of the one or more document sets comprises transmitting one or more messages indicative of authentication credentials to the server computing device and/or to a third party authorization agent.

12. The method of claim 10, wherein said maintaining the one or more copies of the one or more document sets comprises transmitting one or more messages indicative of one or more document set subscription requests to the server computing device.

13. A server computing device, comprising:
a communication interface to push a document set from a server computing device to a client computing device at least in part in response to receiving a subscription request to the document set from the client computing device, wherein the server computing device and the client computing device execute application programming interfaces that are substantially similar to each other.

14. The server computing device of claim 13, the communication interface further to:
maintain a privileged connection with a database comprising the document set; and
retrieve the document set from the database at least in part in response to said receiving the subscription request from the client computing device.

15. The server computing device of claim 14, wherein the client computing device comprises an untrusted client computing device.

16. The server computing device of claim 14, further comprising a processor to detect a modification to the document set, the communication interface further to push one or more messages indicative of the modification to the document set to the client computing device at least in part in response to a detection of the modification to the document set.

17. The server computing device of claim 16, the processor further to detect the modification to the document set at least in part by detecting an insertion of one or more additional documents to the document set and/or by detecting a deletion of one or more documents of the document set.

18. The server computing device of claim 16, the processor further to detect the modification to the document set at least in part by detecting an alteration of one or more documents of the document set.

19. The server computing device of claim 13, the server computing device to push the document set to the client computing device at least in part by:
the processor to determine whether a user associated with the client computing device is authorized to access the document set; and
the communication interface to push the document set from the server computing device to the client computing device and at least in part in response to a determination that the user is authorized.

20. The server computing device of claim 19, the communication interface further to push messages indicative of alterations to the document set to the client computing device to allow the client computing device to maintain a current copy of the document set in a local database cache.

21. The server computing device of claim 20, the communication interface further to push messages indicative of alterations to the document set at least in part by occasionally pushing the messages at least in part in response to respective detections of the alterations to the document set.

22. A client computing device, comprising:
a processor to maintaining one or more copies of one or more document sets from a server-based database in a local cache memory; and
a communication interface to receive pushed messages from a server computing device, the processor to maintaining the one or more copies of the one or more document sets at least in part in response to the communication interface receiving the pushed messages, the processor to execute an application programming interface that is substantially similar to an application programming interface executed by the server computing device.

23. The client computing device of claim 22, the communication interface to transmit one or more messages indicative of authentication credentials to the server computing device and/or to a third party authorization agent.

24. The client computing device of claim 22, the communication interface to transmit one or more messages indicative of one or more document set subscription requests to the server computing device.

25. An article, comprising: a storage medium having stored thereon instructions executable by a server computing device to:
push a document set from the server computing device to a client computing device at least in part in response to receiving a subscription request to the document set from the client computing device, the server computing device to execute an application programming interface that is substantially similar to an application programming interface executed by the client computing device.

26. The article of claim 25, wherein the storage medium has stored thereon further instructions executable by the server computing device to:
maintain a privileged connection with a database comprising the document set; and
retrieve the document set from the database at least in part in response to said receiving the subscription request from the client computing device.

27. The article of claim 26, wherein the client computing device comprises an untrusted client computing device.

28. The article of claim 26, wherein the storage medium has stored thereon further instructions executable by the server computing device to:
detect a modification to the document set; and
push one or more messages indicative of the modification to the document set to the client computing device at least in part in response to a detection of the modification to the document set.

29. The article of claim 28, wherein the storage medium has stored thereon further instructions executable by the server computing device to detect the modification to the document set at least in part by detecting an insertion of one or more additional documents to the document set and/or by detecting a deletion of one or more documents of the document set.

30. The article of claim 28, wherein the storage medium has stored thereon further instructions executable by the server computing device to detect the modification to the document set at least in part by detecting an alteration of one or more documents of the document set.

31. The article of claim 25, wherein the storage medium has stored thereon further instructions executable by the server computing device to:
determine whether a user associated with the client computing device is authorized to access the document set; and
push the document set from the server computing device to the client computing device and at least in part in response to a determination that the user is authorized.

32. The article of claim 31, wherein the storage medium has stored thereon further instructions executable by the server computing device to push messages indicative of alterations to the document set to the client computing device to allow the client computing device to maintain a current copy of the document set in a local database cache.

33. The article of claim 32, wherein the storage medium has stored thereon further instructions executable by the server computing device to push messages indicative of alterations to the document set at least in part by occasionally pushing the messages at least in part in response to respective detections of the alterations to the document set.

34. An article, comprising: a storage medium having stored thereon instructions executable by a client computing device to:
maintain one or more copies of one or more document sets from a server-based database in a local database cache at least in part by receiving pushed messages from a server computing device, the client computing device to execute an application programming interface that is substantially similar to an application programming interface executed by the server computing device.

35. The article of claim 34, wherein the storage medium has stored thereon further instructions executable by the client computing device to maintain the one or more copies of the one or more document sets at least in part by transmitting one or more messages indicative of authentication credentials to the server computing device and/or to a third party authorization agent.

36. The article of claim 34, wherein the storage medium has stored thereon further instructions executable by the client computing device to maintain the one or more copies of the one or more document sets at least in part by transmitting one or more messages indicative of one or more document set subscription requests to the server computing device.
